(19) United States
(12) Patent Application Publication
(10) Pub. No.: US 2016/0180107 A1
(43) Pub. Date: Jun. 23, 2016

(54) METHOD AND SYSTEM FOR POLICY BASED DATA ACCESS CONTROL

(71) Applicants: Ankur Panchbudhe, Pune (IN); Praneeth Siva, Pune (IN); Amol Vaikar, Pune (IN); Yusuf Batterywala, Pune (IN)

(72) Inventors: Ankur Panchbudhe, Pune (IN); Praneeth Siva, Pune (IN); Amol Vaikar, Pune (IN); Yusuf Batterywala, Pune (IN)

(73) Assignee: ANOOSMAR TECHNOLOGIES PRIVATE LIMITED, Pune (IN)

(21) Appl. No.: 14/572,784

(22) Filed: Dec. 17, 2014

(51) Int. Cl. G06F 21/62; H04L 29/06

(52) U.S. Cl. CPC G06F 21/6218; H04L 63/102

(57) ABSTRACT

Disclosed herein are a method and a system for data management. An administrator can configure data access permissions for each user to each file and file folders the user is attributed to. Further, when a user requests data access the system checks whether the user has permission to access that particular file/file folder. If the user is found to have permission to access that particular file/file folder, the system allows the user to access the file/file folder user with permitted read and edit settings. If the user is found to have no access to the requested file/file folder, then the system denies access to the user.

### TECHNICAL FIELD

The embodiments herein relate to information rights management and, more particularly, to policy based data access control in information rights management.

### BACKGROUND

Data management has always been a concern for human beings. As the technology evolved, and with evolution of computers and related storage mediums, the issue of data management was solved to some extent, at least temporarily. However, the same technology growth kept on changing the world, and in recent times, it changed from ‘static’ to ‘dynamic’. This development, followed by introduction of mobile devices into the market, gave birth to new requirements; the prominent one being a centralized mobile data management system.

The popularity that internet gained among the public, and introduction of cloud services helped to fulfill this requirement to a greater extent. Many service providers started offering centralized data management options for the users. A few examples are Google Drive, SharePoint, Documentum, and so on. The centralized data management systems play an important role in an enterprise and business environment. In such environments, storage is hosted at a central server, and employees of the organization are given full/restricted access to the data, based on roles and responsibilities defined by their profiles.

However, the existing centralized data management systems have certain disadvantages. One disadvantage from an enterprise perspective is that an employee may need to be connected to the corporate network to be able to access the centralized data management system. This is inconvenient for mobile workforce, and especially for those who are roaming. Another disadvantage is that the centralized data management systems being used currently requires the user system to have an Operating System (OS) that supports mounting or mapping of content store, or must be supporting execution of client access procedures which may allow access to data from the centralized data management system. This may cause inconvenience to the users, as they may not possess knowledge or permission (s) required to carry out the mounting or mapping process. Further, the existing systems do not offer sufficient and seamless support to mobile devices.

Now, when it comes to data sharing using the centralized data management systems, the user may have to use unmanaged and unapproved cloud services for the purpose of sharing data with other users. Further, sending confidential data as attachment results in replication of the data in the message servers. This might trigger data security and compliance issues. Further, when a file is shared using normal data sharing means, the user generally has no option to control data access permissions of recipients of the file. Though access permissions can be configured at an admin level, this might be extremely inconvenient for the user as the time taken for each user to request and configure admin level rights may be high.

### SUMMARY

In view of the foregoing, an embodiment herein provides a method for data management in an enterprise network. By processing a data access request collected from a user, data indicated by the data access request is identified. Further, access permission of the user to the identified data is checked. If the user has permission to access the data, then the user is allowed access to the identified data. Allowing access to the identified data involves collecting the identified data from all associated data sources, and displaying the collected data with at least one read and edit option. If the user has no permission to access the identified data, then access is denied access to the data.

Embodiments further disclose a system for data management in an enterprise network. The system is configured to collect a data access request from a user, using a data management server. Further, by processing the data access request using the data management server, the system identifies data indicated by the data access request. Further, the system checks if the user has proper access permission to access the identified data. If the user has permissions to access the data, the system, using the data management server, allows access for the user to the identified data. The system allows access to the identified data by collecting the identified data from all associated data sources, and displaying the collected data with at least one read and edit option. If the user has no permission to access the identified data, then the system denies access to the data.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of the data management system, as disclosed in the embodiments herein;

FIG. 2 is a block diagram that depicts various components of a data management server, as disclosed in the embodiments herein; and

FIG. 3 is a flow diagram that shows various steps involved in the process of data management using the data management system, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

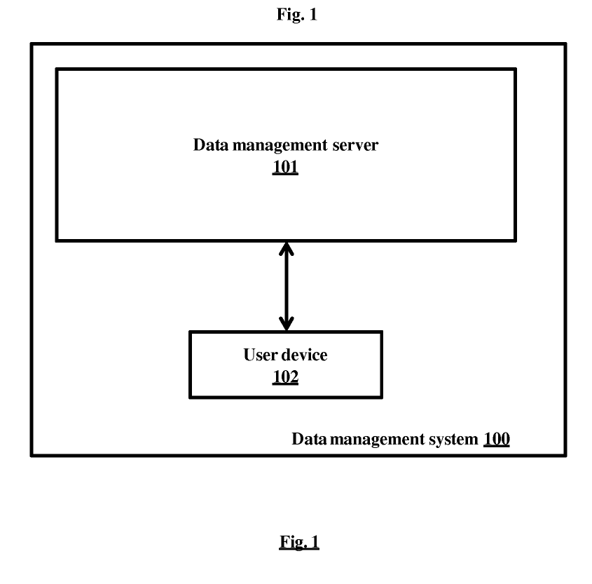

The embodiments herein disclose a policy based data management process by using a data management system. Referring now to the drawings, and more particularly to FIGS. 1 through 3, where similar reference characters denote corresponding features consistently throughout the figures, there are shown embodiments.

FIG. 1 illustrates a block diagram of the data management system, as disclosed in the embodiments herein. The data management system 100 comprises of a data management server 101, and a user device 102. The data management server 101 may be configured to communicate with the user device 102 using a suitable communication channel. The data management server 101, by communicating with the user device 102, is configured to receive a data access request from the user device 102. The data management server 101 is further configured to process the received data access request received from the user device 102, and check data access permissions of that particular user. The data management server 101 is further configured to allow or deny requested data access to the user, based on identified data access permissions for that particular user. The data management server 101 may be further configured to collect data requested by the user, from at least one internal and/or external data source. In an embodiment, collecting data may refer to fetching the data from the data source to the data management server 101. In another embodiment, collecting the data may refer to locating the data, and routing the location information to the user, such that the data may be accessed and processed from the actual location i.e. the data source. The data management server 101 may be further configured to aggregate data collected from more than one data source, and provide the aggregated data to the user, preferably in the form of a single file system, wherein the file system may be a virtual file system.

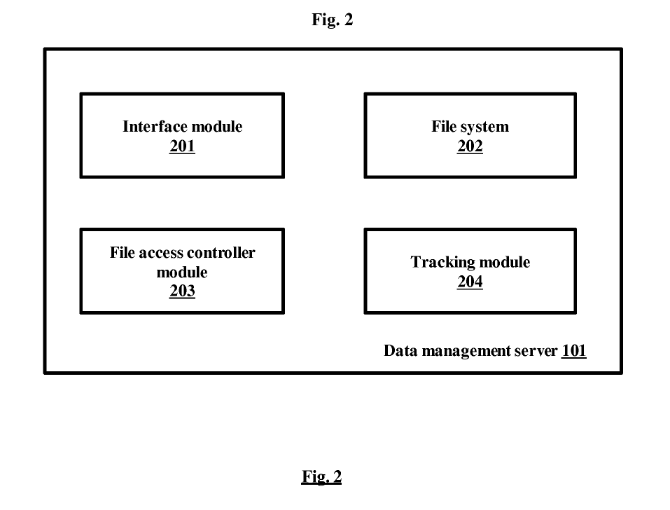

FIG. 2 is a block diagram that depicts various components of a data management server, as disclosed in the embodiments herein. The data management server 101 comprises of an interface module 201, a file system 202, a file access controller module 203, and a tracking module 204.

The interface module 201 is configured to provide suitable communication medium/channel for the data management server 101 to communicate with the user device 102. In various embodiments, the communication medium/channel may be wireless, wired, or a suitable combination thereof. The interface module 201 is further configured to provide response for the data access request, to the user in a suitable format. A few examples of the type of data that the interface module 201 may provide to the user are:
Users' own data that are synchronized from various devices belonging to the user, which are in various locations
Data shared with the user by other users within or outside the organization
Data belonging to the user but residing on different content stores

In another embodiment, the interface module 201 may provide different interfaces that match specifications of the user device. For example, the interface module 201 may be configured to provide different interfaces for mobile phones, laptops and so on. The interface module 201 may be configured to list and show files/file folders a user can access, when the user accesses the system via the interface module 201.

The file system 202 is configured to provide file read and write options for the user. The file system 202 is further configured to support:
internal and external file sharing
user collaboration
online viewing
geo-tracking and device tracking of files
geo, IP, device, OS, and time based fencing
file timelines
file annotations
comments
digital rights management (DRM)
information rights management (IRM)
content management
access tracking
file editing
analytics

The file system 202 may be further configured to store metadata and policies which can be used for providing restricted data access for users. A few examples of the meta data that may be used for providing restricted data access for users are:
Users and groups allowed to access a specific file or folder
Type of access permissions set for each user/user group
File sharing permissions and type of file sharing permitted
Geo location, IP, device, OS, and time data access permissions
Type of user device (s) which has access to a specific file or file folder
Date, and Time based file access permissions

In a preferred embodiment, the file system 202 creates metadata only when a file or file folder is accessed by a user. The file system 202 may be further configured to access and fetch data from a data source, based on data access permissions configured for that particular user, and provide the fetched data to the interface module 201 for processing and displaying to the user, with at least one read & edit permission. The data source may refer to any suitable memory space such as but not limited to a file server, a file-based content management system, and a file versioning system, which may act as a file based data store.

The file access controller module 203 may be regarded as an administrator's interface to the data management server 101. The file access controller module 203 may be configured to provide suitable option (s) for the administrator to interact with, and configure, at least one metadata and at least one rule related to file access permission for each user, pertaining to at least one file or file folder access. The data access permission may indicate whether a user has right to access a particular file/folder, and if yes, type of action (s) the user may perform on that particular file or file folder. The file access controller module 203 may be further configured to provide option (s) for the administrator to define and configure at least one rule related to internal or external file sharing. In an embodiment, the data access permission/rule may be same for all users/user devices 102 associated with the data management server 101. In another embodiment, the data access permission/rule may be user specific such that for a user, the data access permissions may be same for all file/file folders he/she is attributed to. In another embodiment, a user may have different access permissions for different file/file folders. The file access controller module 203 may be further configured to provide at least one option for the administrator to set password protection on shared data, and to share expiry.

The tracking module 204 may be configured to monitor and track activities carried out in association with all files, and file folders saved in the data source associated with the file system 202. Some examples of factors that may be tracked by the tracking module 204 are:
When was the file/file folder created/modified/accessed
Who accessed the file/file folder
Action (s) performed by the user as part of the access (For example read/write/list/download/upload/print etc)
Device used to access the file and its attributes like IP, MAC address, device identifier, type, OS, platform, etc.
IP address details of the user and/or device while accessing the file/file folder
Geo-location of the user and/or device while accessing the file/file folder
Sharing details of the file/file folder
Printing details of a file

In a various embodiments, the tracking module 204 may be configured to monitor and track all or selected parameters with respect to each file or file folder.

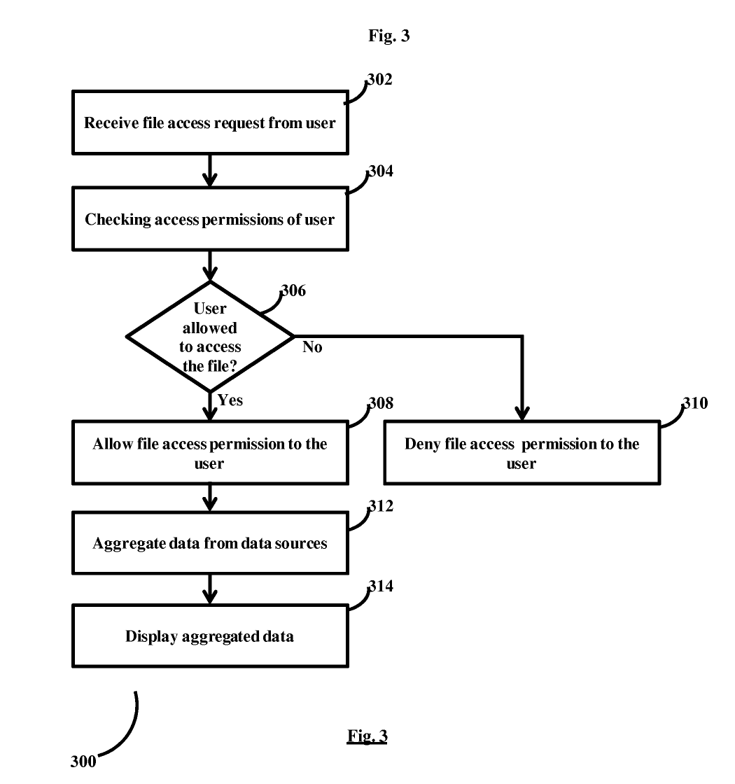

FIG. 3 is a flow diagram that shows various steps involved in the process of data management using the data management system, as disclosed in the embodiments herein. A user can, using a suitable interface client installed on the user device 102, send a data access request to the data management server 101. The interface module 201 collects (302) the user request, and transfers the request to the file system 202. In an embodiment, the interface module 201 may process the user request to convert it to a suitable format that allows further processing of the user request at the file system 202.

The file system 202, by processing the user request, identifies the file/file folder to which the user requesting access. In an embodiment, the user request may comprise of any specific identifier that is unique to a file/file folder the user is trying to access. In that case, the file system 202 may compare the unique identifier extracted from the user request with a database which comprises of information about unique identifier pertaining to file/file folder, to identify the file/file folder the user is trying to access. The database may further comprise of information related to access permission allowed for each user corresponding to each file/file folder the user (s) is attributed to. Based on the information stored in the database, the file system 202 checks (304) access permissions of the user to the requested file/file folder. This process may involve the file system 202 comparing a user specific data with the database that possesses information on access permission of the user to all files/file folders the user is attributed to. If the user is permitted to access the file/file folder, then the file system 202 allows (308) access to the specified file/file folder, fetches the data corresponding to the requested file/file folder from an associated data source, with suitable permissions/access settings. The permission/access setting may refer to the type of action (s) the user may perform, on that particular file/file folder. For example, if the user is permitted access to the requested file with read & edit options, the file system fetches the file data from the file server and presents it to the user with at least one read & edit option. A few examples of the edit permission are, but not limited to browse, create, view, edit, upload, delete, share, comment, download, refresh, offline access, approval, self destruct, attach, forward, and expire.

If the file system 202 identifies that the user has no permission to access the requested file/file folder, then the user is denied (310) access to the requested file/file folder. The various actions in method 300 may be performed in the order presented, in a different order or simultaneously. Further, in some embodiments, some actions listed in FIG. 3 may be omitted.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiments disclosed herein specify a system for data management. The mechanism allows rule and metadata based data management, providing a system thereof. Therefore, it is understood that the scope of protection is extended to such a system and by extension, to a computer readable means having a message therein, said computer readable means containing a program code for implementation of one or more steps of the method, when the program runs on a server or mobile device or any suitable programmable device. The method is implemented in a preferred embodiment using the system together with a software program written in, for ex. Very high speed integrated circuit Hardware Description Language (VHDL), another programming language, or implemented by one or more VHDL or several software modules being executed on at least one hardware device. The hardware device can be any kind of device which can be programmed including, for ex. any kind of a computer like a server or a personal computer, or the like, or any combination thereof, for ex. one processor and two FPGAs. The device may also include means which could be for ex. hardware means like an ASIC or a combination of hardware and software means, an ASIC and an FPGA, or at least one microprocessor and at least one memory with software modules located therein. Thus, the means are at least one hardware means or at least one hardware-cum-software means. The method embodiments described herein could be implemented in pure hardware or partly in hardware and partly in software. Alternatively, the embodiment may be implemented on different hardware devices, for ex. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for data management in an enterprise network, said method comprising:
collecting a data access request from a user, using a data management server;
identifying data indicated by said data access request, using said data management server;
checking access permission of said user to said identified data, using said data management server;
denying access if said user has no permission for said access to said identified data, using said data management server; and
allowing access if said user has permission for said access to said identified data using said data management server, wherein said allowing access further comprises,
collecting said identified data from at least one data source; and
displaying said collected data to said user with at least one read and edit permission.

2. The method as claimed in claim 1, wherein identifying said data indicated by said data access request further comprises of:
extracting an identifier from said data access request using said data management server, wherein said identifier is unique to each data;
comparing said extracted identifier with a database using said data management server, wherein said database maps data and corresponding unique identifier; and
identifying said data corresponding to said extracted identifier, using said data management server.

3. The method as claimed in claim 1, wherein said identified data is located in the same data source.

4. The method as claimed in claim 1, wherein said identified data is located in the different data sources.

5. The method as in claim 1, wherein checking access permission of said user to said identified data further comprises of comparing a user specific data with a database, wherein said database possesses information on access permission of said user to each file said user is attributed to.

6. The method as in claim 1, wherein said identified data is at least one file.

7. The method as in claim 1, wherein said identified data is at least one file folder.

8. The method as claimed in claim 1, wherein permission to access said identified data is allowed based on at least one of a date, time, geo-location, IP address, MAC address, type of access, device identifier, type of device, device platform, and Operating System (OS).

9. The method as claimed in claim 1, wherein said at least one edit permission is at least one of browse, create, view, edit, upload, delete, share, comment, download, refresh, offline access, approval, self destruct, attach, forward, and expire.

10. A system for data management in an enterprise network, said system comprising:
a hardware processor; and
a memory for storing computer executable instructions that when executed by the hardware processor, cause the hardware processor to perform at least,
collecting at least one data access request from a user, using a data management server;
identifying data indicated by said at least one data access request, using said data management server;
checking access permission of said user to said identified data, using said data management server;
denying access if said user has no permission to access said identified data, using said data management server; and
allowing access if said user has permission to access said identified data using said data management server, wherein said allowing access further comprises,
collecting said identified data from at least one data source; and
displaying said collected data to said user with at least one read and edit permission.

11. The system as in claim 10, wherein said data management server is further configured to identify said data indicated by said data access request by:
extracting an identifier from said data access request using a file system, wherein said identifier is unique to each data;
comparing said extracted identifier with a database using said file system, wherein said database maps data and corresponding unique identifier; and
identifying said data corresponding to said extracted identifier, using said file system.

12. The system as claimed in claim 11, wherein said file system is further configured to support at least one of an internal file sharing, external file sharing, user collaboration, online viewing, geo-tracking and device tracking of files, fencing, file timelines, file annotations, comments, digital rights management (DRM), information rights management (IRM), content management, access tracking, file editing, and analytics.

13. The system as in claim 10, wherein said data management server is further configured to check access permission of said user to said identified data by comparing a user specific data with a database, using a file system, wherein said database possesses information on access permission of said user to each file said user is attributed to.

14. The system as claimed in claim 10, wherein data management server is further configured to allow permission to access said identified data based on at least one of a date, time, geo-location, IP address, MAC address, type of access, device identifier, type of device, device platform, and Operating System (OS).

15. The system as claimed in claim 10, wherein said data management server is further configured to provide at least one of browse, create, view, edit, upload, delete, share, comment, download, refresh, offline access, approval, self destruct, attach, forward, and expire, as said edit permission.
